(19) United States
(12) Patent Application Publication
(10) Pub. No.: US 2020/0081921 A1
(43) Pub. Date: Mar. 12, 2020

(54) APPARATUS FOR PROVIDING PREACHING, METHOD FOR PROVIDING PREACHING, AND COMPUTER-READABLE MEDIUM THEREFOR

(71) Applicant: POPOINC, LLC, Tokyo (JP)

(72) Inventors: Yasuhiko Yokote, Tokyo (JP); Hitomi Yokote, Tokyo (JP)

(73) Assignee: POPOINC, LLC, Tokyo (JP)

(21) Appl. No.: 16/372,307

(22) Filed: Apr. 1, 2019

(30) Foreign Application Priority Data
Sep. 10, 2018 (JP) 2018-169098

(51) Int. Cl. G06F 16/9038; G06F 3/0482; G06F 16/93

(52) U.S. Cl. CPC G06F 16/9038; G06F 16/93; G06F 3/0482

(57) ABSTRACT

There is provided a computer-readable medium on which a computer program is recorded, said computer program causes, when executed, the computer to perform a method comprising the steps of: a) displaying a preaching on a display, said preaching citing at least one portion in the Bible; b) retrieving at least one preaching which includes a common portion with the preaching displayed at step a) or at least one preaching which is related to the preaching displayed at step a), said common portion includes at least one cited portion or Lord's word in the Bible which is commonly cited from said preaching displayed at step a) and said at least one preaching retrieved at step b); c) displaying a list including said at least one preaching retrieved at step b); and d) displaying a preaching selected from said list displayed at step c).

### BACKGROUND

### Technical Field

The present invention relates to an apparatus for providing preachings, a method for providing preachings, and a computer-readable medium therefor.

### Related Art

There has been applications for displaying the Bible on portable information processing apparatus. Such applications only display the text of the Bible, and search the Bible for portions including a keyword.

### SUMMARY

An object of the present invention is to provide an apparatus, a method, and a computer-readable medium which provide a user with preachings performed in worships at churches in various regions every Lord's day in such a way that the preachings are related to portions in the Bible which are cited in the preachings.

According to one aspect of the present invention, there is provided a computer-readable medium on which a computer program is recorded, said computer program causes, when executed, the computer to perform a method comprising the steps of:

a) displaying a preaching on a display, said preaching citing at least one portion in the Bible;

b) retrieving at least one preaching which includes a common portion with the preaching displayed at step a) or at least one preaching which is related to the preaching displayed at step a), said common portion includes at least one cited portion or Lord's word in the Bible which is commonly cited from said preaching displayed at step a) and said at least one preaching retrieved at step b);

c) displaying a list including said at least one preaching retrieved at step b);

d) displaying a preaching selected from said list displayed at step c).

According to another aspect of the present invention, there is provided a computer-readable medium on which a computer program is recorded, said computer program causes, when executed, the computer to perform a method comprising the steps of:

a) displaying a preaching on a display, said preaching citing at least one portion in the Bible;

b) causing another computer to retrieve at least one preaching which includes a portion common with the preaching displayed at step a) or at least one preaching which is related to the preaching displayed at step a), said common portion includes at least one cited portion or Lord's word in the Bible which is commonly cited from said preaching displayed at step a) and said at least one preaching retrieved at step b);

c) displaying a list including said at least one preaching retrieved at step b);

d) displaying a preaching selected from said list displayed at step c).

According to the present invention, it is possible to provide a user with preachings performed in worships at churches in various regions every Lord's day in such a way that the preachings are related to portions in the Bible which are cited in the preachings.

### BRIEF DESCRIPTION OF DRAWINGS

FIG. 1 is a functional block diagram showing a structure of a portable information processing apparatus according to an embodiment of the present invention;

FIG. 2 shows a structure of a table included in a database as shown in FIG. 1 according to the first embodiment of the present invention;

FIG. 3 shows a screen including a main menu displayed by an application program for displaying preachings;

FIG. 4 shows a screen which is displayed when “latest preachings” is selected from the main menu and which includes titles of latest preachings;

FIG. 5 shows a screen which is displayed when “preachings for each church/church list” is selected from the main menu and which includes the main menu and a secondary menu of churches;

FIG. 6 shows a screen which is displayed when “preachings for each denomination/denomination list” is selected from the main menu and which includes the main menu and a secondary menu of denominations;

FIG. 7 shows a screen which is displayed when “preachings for each preacher/preacher list” is selected from the main menu and which includes the main menu and a secondary menu of preachers;

FIG. 8 is a screen which is displayed when the fourth title “the history of Israel (2) two nations” is selected on the screen as shown in FIG. 4 or when the first title “the history of Israel (2) two nations” is selected on the preach list of “denomination “Jesus Christ Church in Japan” as shown in FIG. 12, and which shows the preachings entitled “the history of Israel (2) two nations”;

FIG. 9 is a WEB page which is pop-up displayed when “OGIKUBO GLORY CHURCH” is selected on a screen of “the history of Israel (2) two nations” as shown in FIG. 8;

FIG. 10 shows a screen of a list menu of preachings held in “TACHIKAWA GOSPEL FREEDOM CHURCH”, wherein the list menu is displayed when “TACHIKAWA GOSPEL FREEDOM CHURCH” at the second top in the secondary menu of churches in FIG. 5 is selected;

FIG. 11 shows a screen of a preaching entitled “Living way which causes anger of YHWH” which is displayed when “Living way which causes anger of YHWH at the top in the menu list of preachings held in “TACHIKAWA GOSPEL FREEDOM CHURCH” as shown in FIG. 10;

FIG. 12 shows a screen of a menu list of preachings of denomination “Jesus Christ Church in Japan”, wherein the menu list is displayed when “Jesus Christ Church in Japan” at the second top in the secondary menu of denominations as shown in FIG. 6 is selected;

FIG. 13 is a screen in a state that a secondary list menu of preachers is inserted under menu item “preachings grouped for each preacher/list of preachers” when it is selected from the main menu;

FIG. 14 is a screen in a state that a secondary list menu is inserted under menu item “special preaching series” when it is selected from the main menu;

FIG. 15 shows a screen of list menu of preachings of “First epistle to the Corinthians” by Reiji O. which is displayed when “First epistle to the Corinthians” by Reiji O. at the top of the secondary menu of “special preaching series” as shown in FIG. 14 is selected;

FIG. 16 is a screen of a preaching of “Reward for Christians”, citing First epistle to the Corinthians-3.10-3.15 displayed as a result of a predetermined operation;

FIG. 17 is a screen of a preaching of “Reward for Christians” shown in FIG. 16 and a pop-up menu for selecting which preaching is retrieved when a menu button on the screen is pressed, to be displayed;

FIG. 18 is a diagram showing a list screen of preachings citing the same verse which is displayed when “citing the same verse” is selected in the pop-up menu shown in FIG. 17;

FIG. 19 is a diagram showing a list screen of preachings citing the same chapter which is displayed when “citing the same chapter” is selected in the pop-up menu shown in FIG. 17;

FIG. 20 is a diagram showing a list screen of preachings citing the same chapter which is displayed when “citing the same book” is selected in the pop-up menu shown in FIG. 17;

FIG. 21 is a diagram showing a screen of a preaching of “We, the church of GOD” citing First epistle to the Corinthians-3.10-3.15 displayed when the first title “We, the church of GOD” is selected on the preaching list screen shown in FIG. 18 or the second title “We, the church of GOD” is selected on the preaching list screen shown in FIG. 17;

FIG. 22 is a diagram showing a screen of a preaching of “GOD grows us” citing First epistle to the Corinthians-3.4-3.9 displayed when the first title “GOD grows us” is selected on the preaching list screen shown in FIG. 20;

FIG. 23 shows a structure of the table included in the database as shown in FIG. 1 according to a second embodiment of the present invention;

FIG. 24 is a diagram for describing a book cited in common in a fourth embodiment of the present invention;

FIG. 25 is a diagram for describing a chapter cited in common in the fourth embodiment of the present invention;

FIG. 26 is a diagram for describing a verse cited in common in the fourth embodiment of the present invention;

FIG. 27 is a diagram for describing a method for retrieving other preachings in order of strong relationship with respect to a preaching which is focused using a bible graph in a fifth embodiment of the present invention;

FIG. 28 is a functional block diagram showing a structure of a portable information processing apparatus according to an eighth embodiment of the present invention;

FIG. 29 is a functional block diagram showing a structure of a server apparatus according to the eighth embodiment of the present invention; and

FIG. 30 is a diagram showing an example of specifications of an API used in the eighth embodiment of the present invention.

### DETAILED DESCRIPTION

Embodiments of the present invention will be described below with reference to the accompanying drawings.

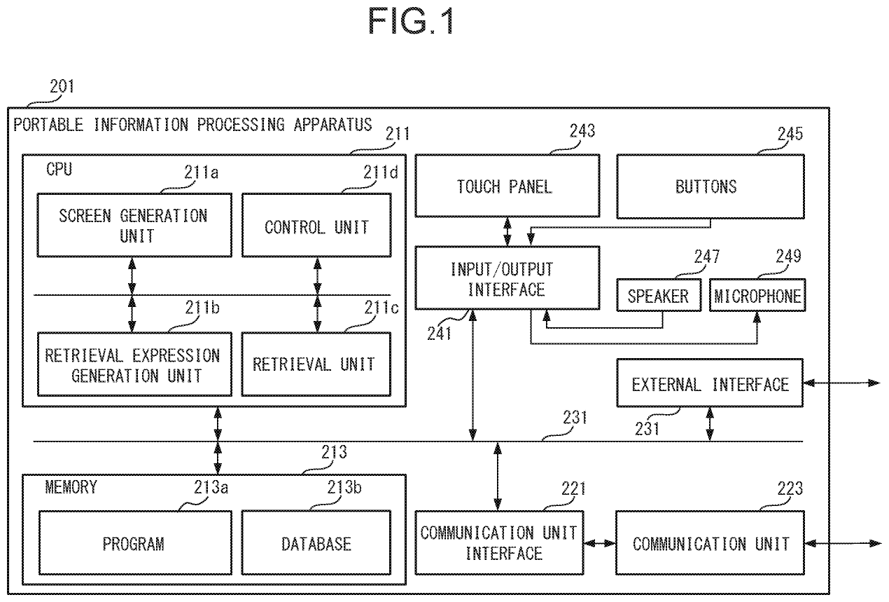

Referring to FIG. 1, a portable information processing apparatus according to the present embodiment includes a CPU 211, a memory 213, a communication unit interface 221, a communication unit 223, an external interface 231, an input/output interface 241, a touch panel 243, buttons 245, a speaker 247, and a microphone 249.

The CPU 211 includes a screen generation unit 211a, a retrieval expression generation unit 211b, a retrieval unit 211c, and a control unit 211d.

The memory 213 stores a program 213a and a database 213b.

The CPU 211 functions as the screen generation unit 211a, the retrieval expression generation unit 211b, the retrieval unit 211c, and the control unit 211d by reading and executing the program 213a of a pastor's preaching application from the memory 213.

The screen generation unit 211a generates a screen to be displayed on a screen of the touch panel 243.

The retrieval expression generation unit 211b generates a retrieval expression for retrieving data generated on the screen from the database 213b.

The retrieval unit 211c acquires data from the database 213b based on the retrieval expression generated by the retrieval expression generation unit 211b.

The control unit 211d controls the screen generation unit 211a, the retrieval expression generation unit 211b, and the retrieval unit 211c.

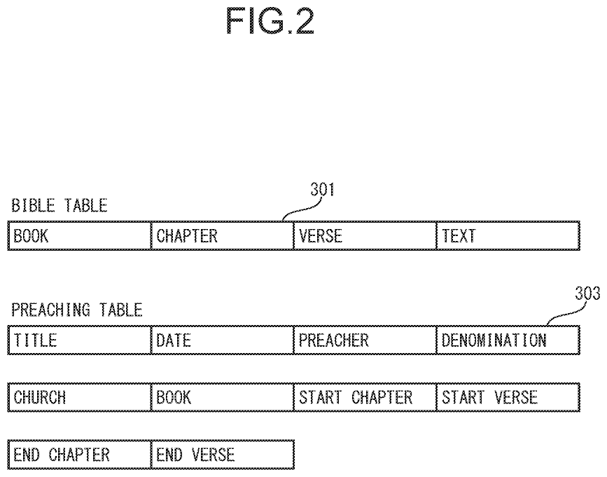

As shown in FIG. 2, the database 211b includes a Bible table 301 and a preaching table 303.

The bible table 301 has fields of books, chapters, verses, and texts. The Bible table 301 includes texts corresponding to 39 Old Testament volumes and 27 New Testament volumes. However, the texts are divided every volume and every verse and each record stores each volume number, each verse number, and texts corresponding to these combinations. For example, the Genesis Chapter 1 Verse 1 “In the beginning God created the heaven and the earth” as a text is recorded in one record in which book number is 1, chapter number is 1, and verse number is 1. In addition, “the genealogy of Jesus Christ, the son of David, the son of Abraham” in the Gospel of Matthew Chapter 1 Verse 1, as a text is recorded in one record in which a book number is 40 and a chapter number is 1.

The preaching table 303 has fields of a title, a date, a preacher, a denomination, a church, a book, a start chapter, a start verse, an end chapter, and an end verse.

The title is a title of a preaching to be displayed on the screen.

The date is a date when a preaching was done.

The preacher is a name of a pastor who preached.

A denomination is a denomination to which a preacher belongs. Alternatively, the denomination may be a denomination of a church where a preaching was done.

The church is a church where a preaching was done.

The book, the start chapter, the start verse, the end chapter, and the end verse indicate what part of the Bible the preaching cites. Specifically, they indicate that the preaching was done by citing from what start chapter and start verse to what end chapter and end verse of what book of the Bible.

The communication unit interface 221 and the communication unit 223 can transmit and receive voice and transmit and receive data.

The external interface 231 can input and output data to and from a device connected thereto.

The touch panel 243 and the user interface 241 can display an image and receive an input by a touch operation.

The buttons 245 and the user interface 241 can receive an operation for each button.

The speaker 247 and the user interface 241 can output voice.

The microphone 249 and the user interface 241 can input voice.

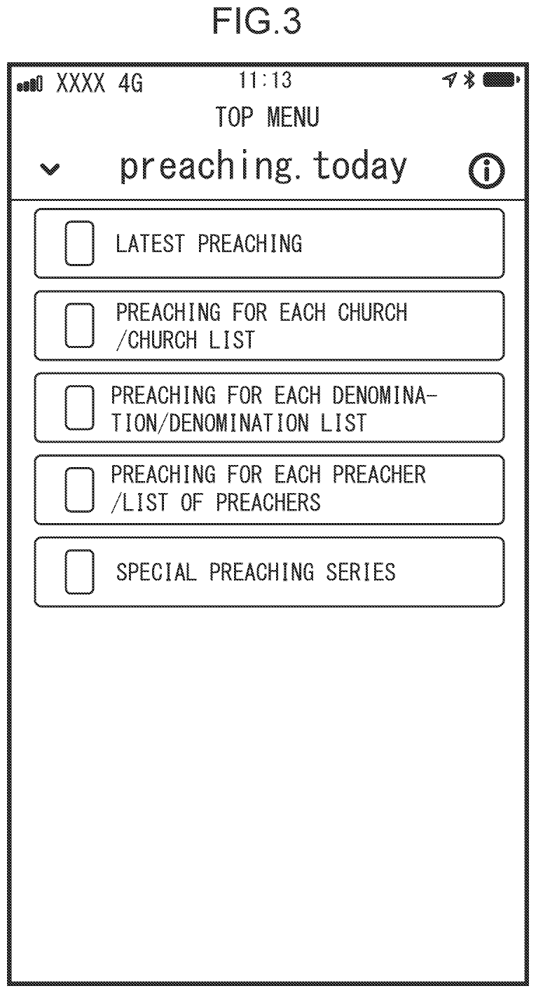

Next, the screen which the CPU 211 executing the pastor's preaching application displays on the touch panel 243 will be described with reference mainly to FIGS. 3 to 22.

FIG. 3 shows the screen of the main menu displayed by the pastor's preaching application. The following menu items are displayed on the screen.

The latest preaching

Preachings for each church/church list

Preachings for each denomination/denomination list

Each preacher/list of preachers

Special preaching series

A part of these may be omitted, and a menu for displaying the list of preachings retrieved based on the connection related to various texts of the Bible as described later in a fifth embodiment may be added, but the present embodiment is not limited thereto.

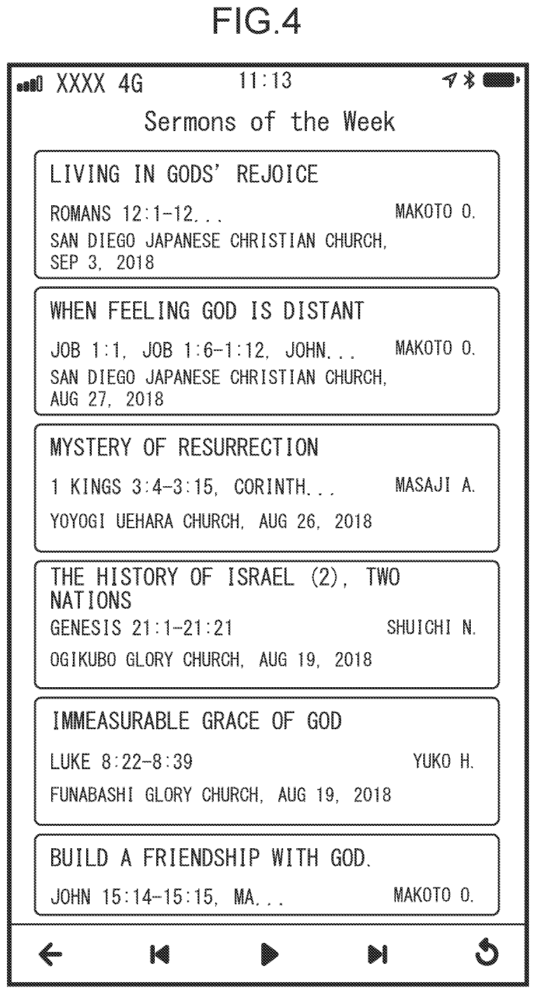

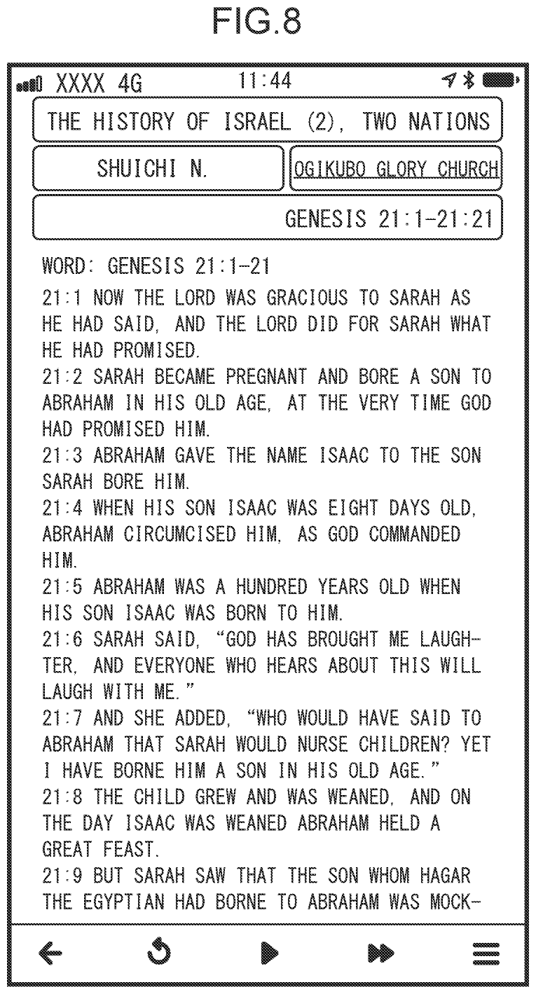

When the “latest preaching” is selected in the main menu shown in FIG. 3, the screen of the list menu of the latest preachings as shown in FIG. 4 is displayed. If a preaching in any title is selected on this screen, the screen of the preaching will be displayed. The format is as shown in FIG. 8, but the specific description is omitted herein.

As the latest preaching, a preaching done within a predetermined number of days from today is selected based on a date of a preaching day recorded in the preaching table 303 and a today's date.

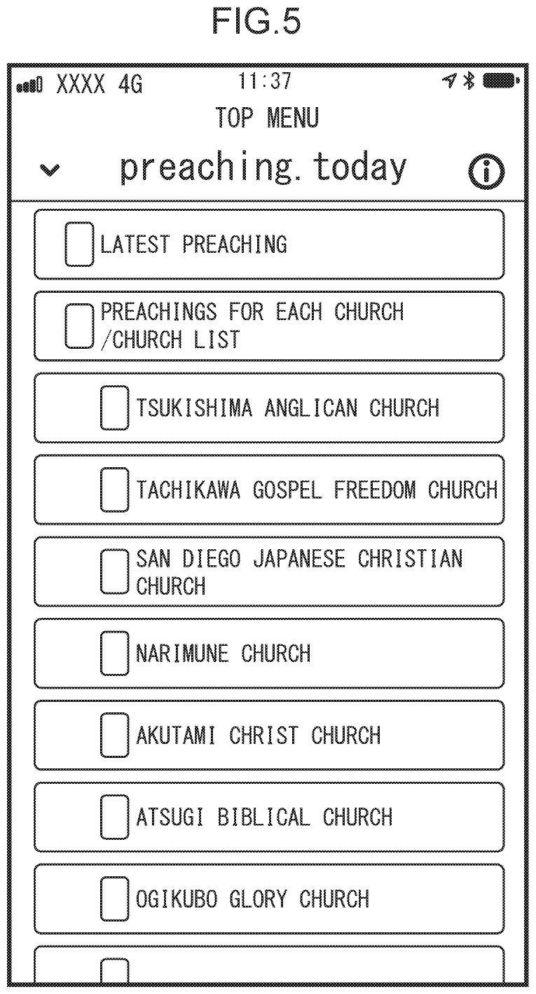

When the “preachings for each church/church list” is selected in the main menu shown in FIG. 3, as shown in FIG. 5, a screen in a state where a secondary menu of a church list is inserted is displayed below the main menu.

The churches displayed in the secondary menu of the church list are all the churches recorded in the preaching table 303.

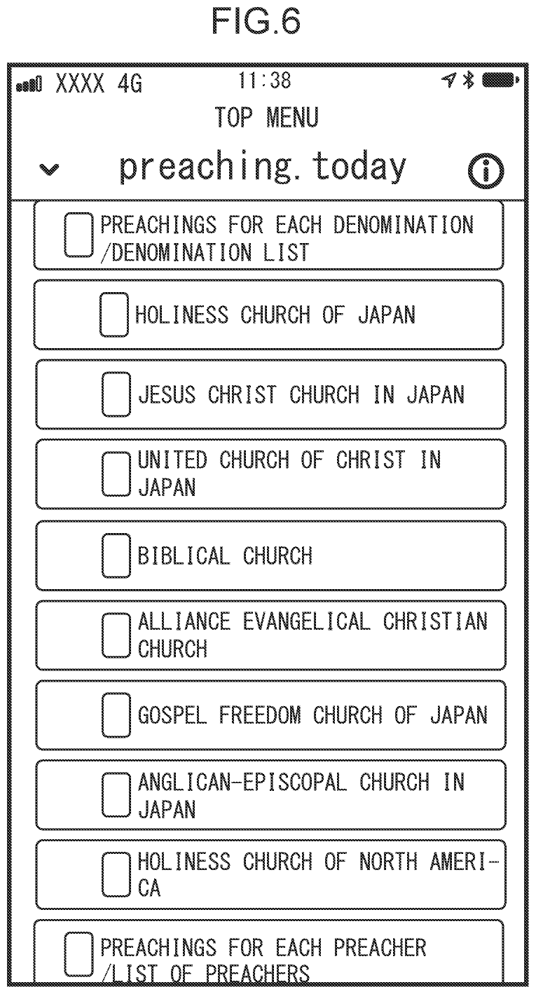

When the “preachings for each denomination/denomination list” is selected in the main menu shown in FIG. 3, as shown in FIG. 6, a screen in a state where the secondary menu of the denomination list is inserted is displayed below the main menu.

The churches displayed in the secondary menu of the denomination list are all the denominations recorded in the preaching table 303.

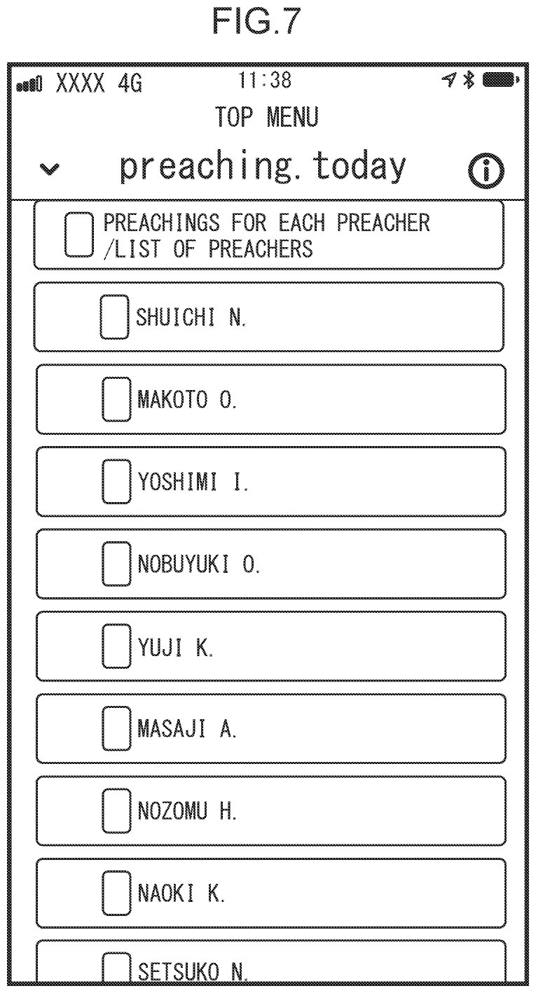

When the “preachings for each preacher/list of preachers” is selected in the main menu shown in FIG. 3, as shown in FIG. 7, the screen in a state where the secondary menu of the list of preachers is inserted is displayed below the main menu.

The churches displayed in the secondary menu of the denomination list are all the preachers recorded in the preaching table 303.

When “the history of Israel (2) two nations” in the fourth title is selected in the list menu of the latest preachings shown in FIG. 4, the screen of the preaching of “the history of Israel (2) two nations” as shown in FIG. 8 is displayed.

As shown in FIG. 8, “the history of Israel (2) two nations” is displayed as a title on the screen, “Shuichi N.” as the preacher is displayed, “OGIKUBO GLORY CHURCH” is displayed as a church, and the “Genesis 21.1-21.21” is displayed as the corresponding portion of the Bible related to the content of preaching. Here, the “Genesis 21.1-21.21” refers to the Genesis Chapter 21 Verses 1 to 21. The “Genesis 21.1-21.21” is a character string which is generated based on a book whose preaching table=1, start chapter=1, start verse=1, end chapter=21, and end verse=21. The field of the character string generated in this way may be provided in the table in advance. Here, reference is made to a table (not shown) showing the correspondence (for example, the correspondence between 1 and the Genesis) between a number indicating a book and a name of the book.

As shown in FIG. 8, a text of a preaching that Shuichi N., a preacher cites from the Genesis Chapter 21 Verses 1 to 21 in the OGIKUBO GLORY CHURCH is displayed as a text on this screen. In addition, when a play button on the screen is pressed, a reading voice is generated based on the text, and the speaker 247 outputs the reading voice.

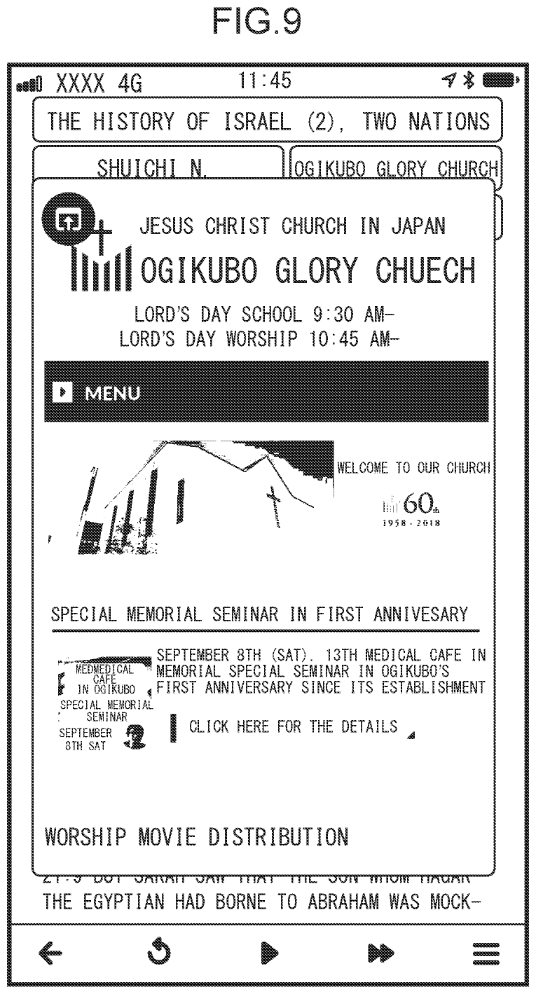

If the “OGIKUBO GLORY CHURCH” is selected on the screen of FIG. 8, a web page of the “OGIKUBO GLORY CHURCH” as shown in FIG. 9 is popped up. Starting from this web page, it is possible to browse the web site and the like.

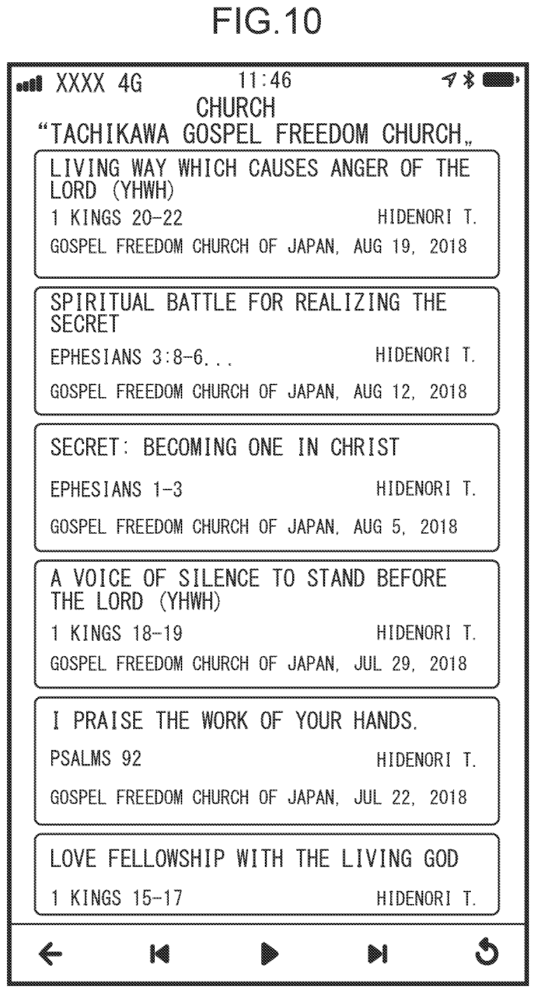

FIG. 10 shows a screen of a list menu of preachings held in “TACHIKAWA GOSPEL FREEDOM CHURCH”, wherein the list menu is displayed when “TACHIKAWA GOSPEL FREEDOM CHURCH” at the second top in the secondary menu of churches in FIG. 5 is selected.

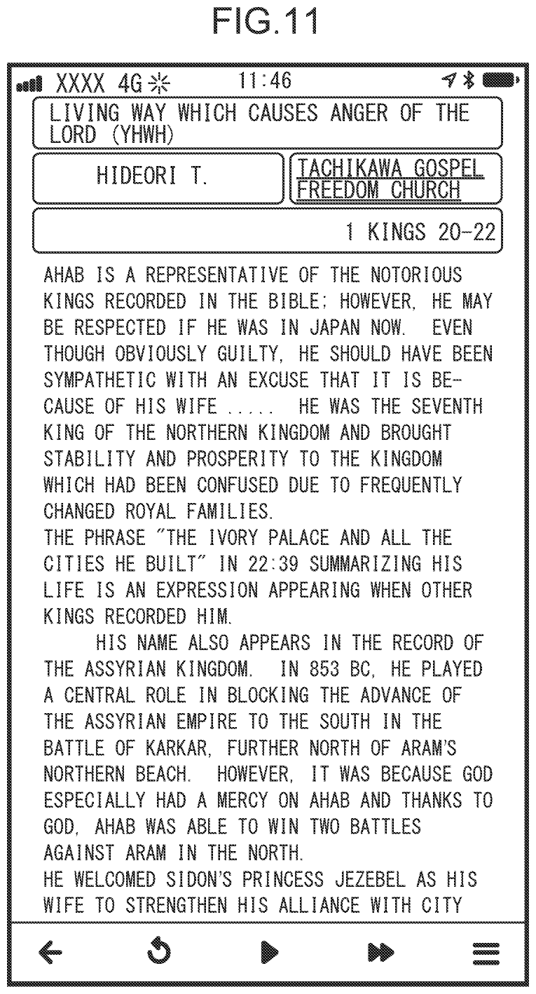

FIG. 11 shows a screen of a preaching entitled “Living way which causes anger of YHWH” which is displayed when “Living way which causes anger of YHWH” at the top in the menu list of preachings held in “TACHIKAWA GOSPEL FREEDOM CHURCH” as shown in FIG. 10.

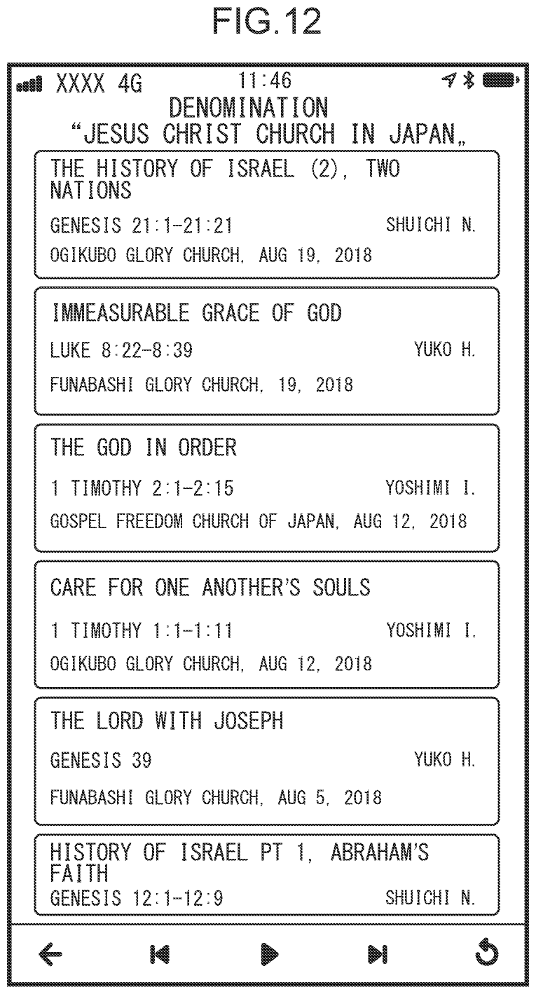

FIG. 12 shows a screen of a menu list of preachings of denomination “Jesus Christ Church in Japan”, wherein the menu list is displayed when “Jesus Christ Church in Japan” at the second top in the secondary menu of denominations as shown in FIG. 6 is selected.

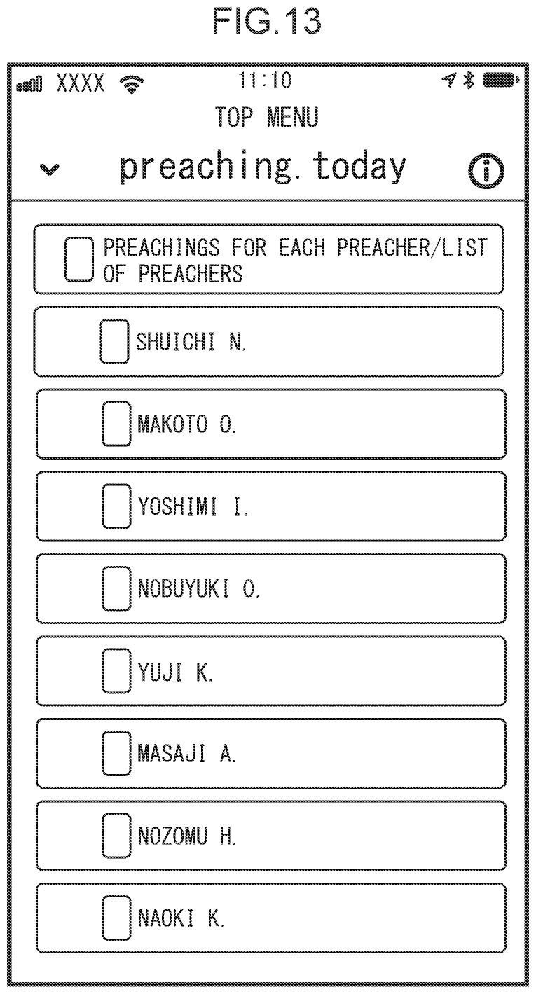

When the “preachings for each preacher/list of preachers” is selected in the main menu, as shown in FIG. 13, the screen in a state where the secondary menu of the list of preachers is inserted is displayed below the main menu.

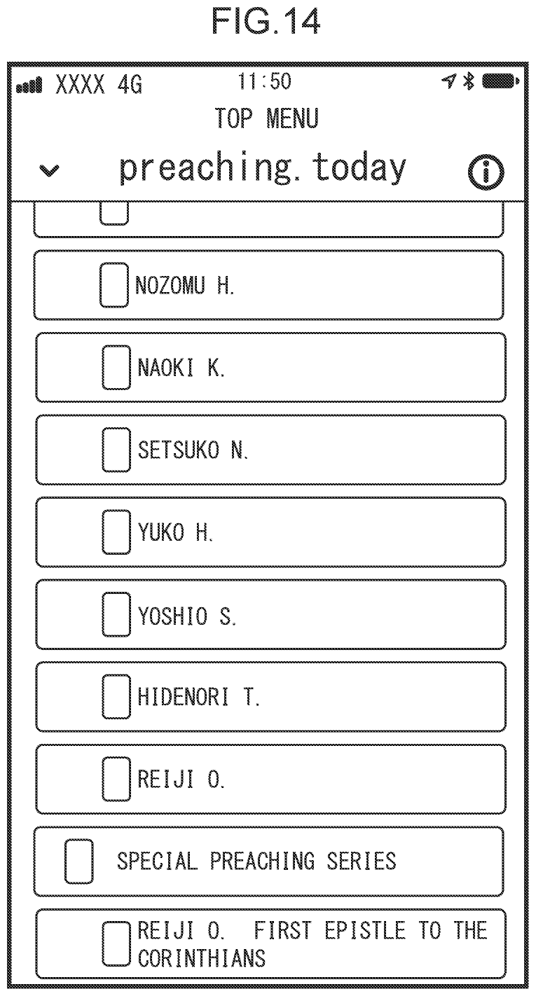

When the “special preaching series” is selected in the main menu, as shown in FIG. 14, the screen in a state where the secondary menu of the list of preachers is inserted is displayed below the main menu.

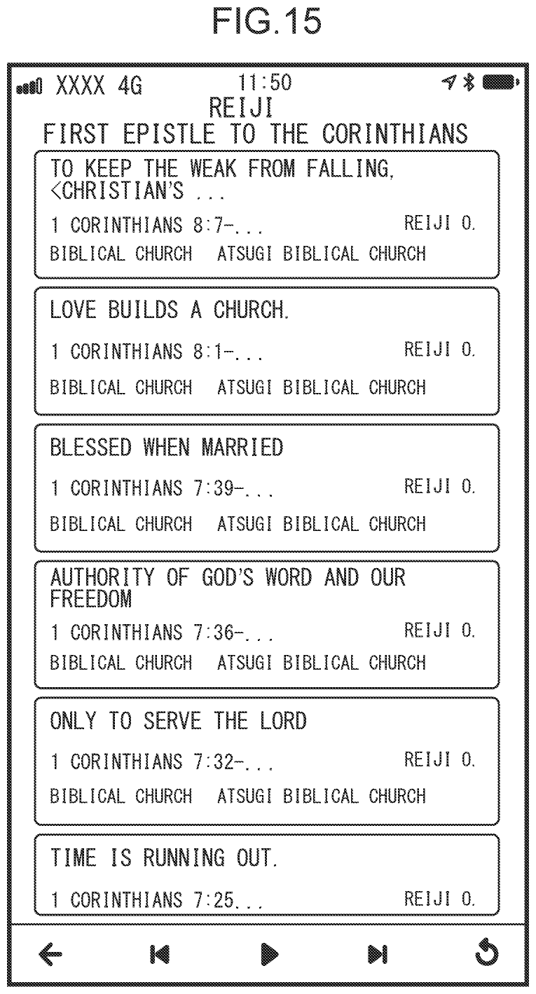

FIG. 15 shows a screen of list menu of preachings of “First epistle to the Corinthians” by Reiji O. which is displayed when “First epistle to the Corinthians” by Reiji O. at the top of the secondary menu of “special preaching series” as shown in FIG. 14 is selected.

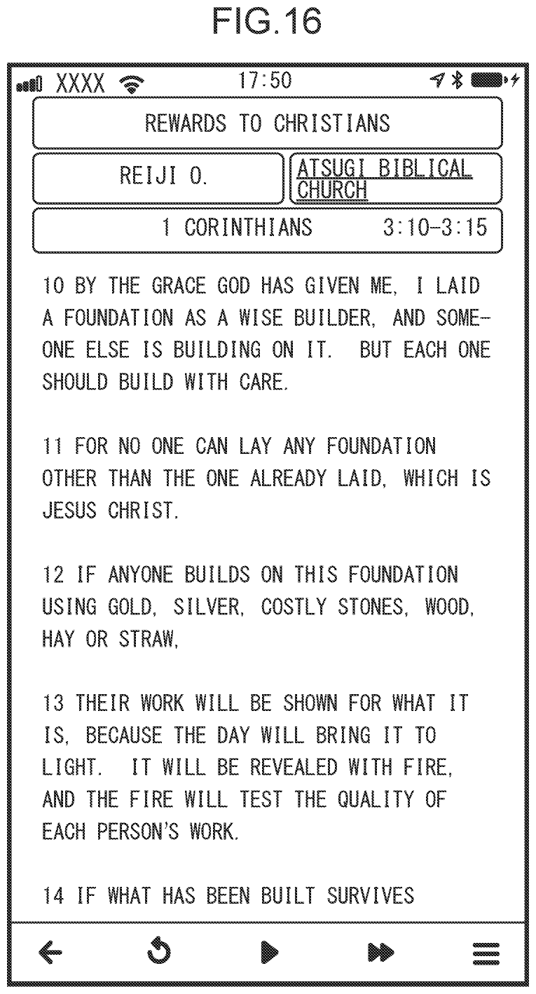

FIG. 16 is a screen of a preaching of “Reward for Christians”, citing First epistle to the Corinthians-3.10-3.15 displayed as a result of a predetermined operation.

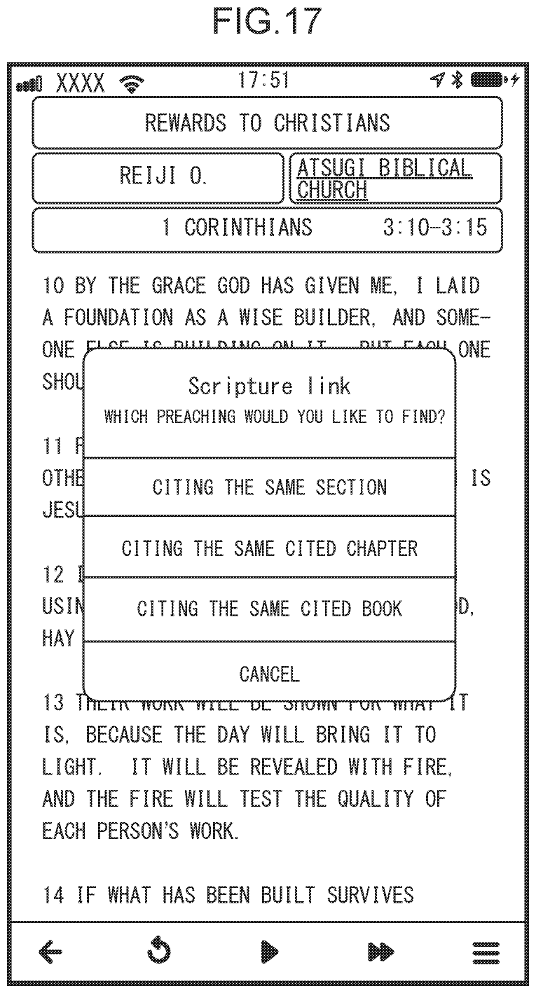

FIG. 17 is a diagram showing a pop-up menu for selecting which a preaching is retrieved when a menu button at the bottom right corner on the screen of a preaching of “Reward for Christians” shown in FIG. 16 is pressed.

The pop-up menu includes the following menu items as the menu items.

Citing the same verse

Citing the same chapter

Citing the same book

Canceling

If the “citing the same verse” is selected, since the Bible shown in FIG. 16 is the First epistle to the Corinthians Chapter 3 Verse 10 to Chapter 3 Verse 15, from the preaching table 303, a retrieval expression for retrieving a record in which a numerical value of a book is a numerical value corresponding to the epistle to the Corinthians, and at least one of one or more chapters and verses included in a start chapter and a start verse to an end chapter and an end verse is a range from Chapter 3 Verse 10 to Chapter 3 Verse 15 is generated by the retrieval expression generation unit 211b.

Instead, from the preaching table 303, a retrieval expression for retrieving a record in which the numerical value of the book is the numerical value corresponding to the epistle to the Corinthians and a start chapter and a start verse is Chapter 3 Verse 10 may be generated by the retrieval expression generation unit 211b.

In addition, from the preaching table 303, a retrieval expression for retrieving a record in which the numerical value of the book is the numerical value corresponding to the epistle to the Corinthians, and a start chapter and a start verse is Chapter 3 Verse 10 and an end chapter and an end verse is Chapter 3 Verse 15 may be generated by the retrieval expression generation unit 211b.

The retrieval unit 211c retrieves the preaching table 303 using the retrieval expression generated by the retrieval expression generation unit 211b.

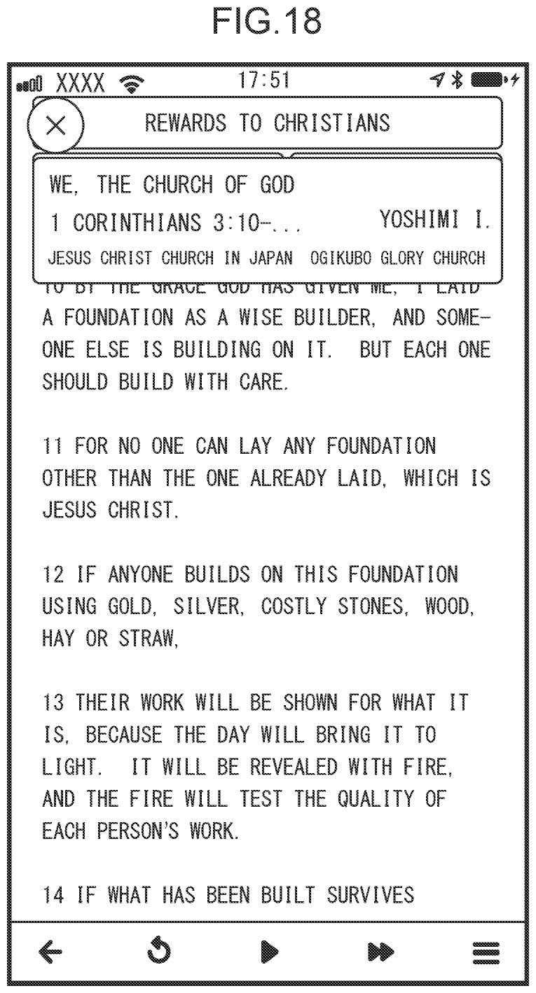

The only preaching title “We, the church of GOD” retrieved is displayed as shown in FIG. 18.

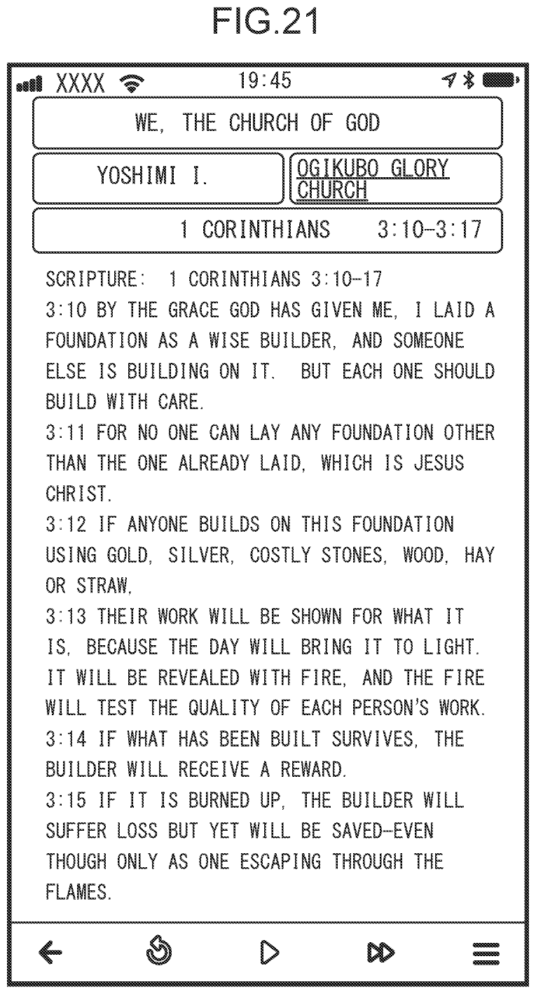

If “We, the church of GOD” is selected on the screen of FIG. 18, a screen of a preaching of “We, the church of GOD” is displayed as shown in FIG. 21.

If the “citing the same chapter” is selected, since the Bible shown in FIG. 16 is the First epistle to the Corinthians Chapter 3 Verse 10 to Chapter 3 Verse 15, from the preaching table 303, a retrieval expression for retrieving a record in which a numerical value of a book is a numerical value corresponding to the epistle to the Corinthians, and at least one of one or more chapters included in a start chapter to an end chapter is in a range from Chapter 3 is generated by the retrieval expression generation unit 211b.

Instead, from the preaching table 303, a retrieval expression for retrieving a record in which a numerical value of the book is a numerical value corresponding to the epistle to the Corinthians, and a start chapter is Chapter 3 may be generated by the retrieval expression generation unit 211b.

In addition, from the preaching table 303, a retrieval expression for retrieving a record in which a numerical value of the book is a numerical value corresponding to the epistle to the Corinthians, a start chapter is Chapter 3, and an end chapter is Chapter 3 may be generated by the retrieval expression generation unit 211b.

The retrieval unit 211c retrieves the preaching table 303 using the retrieval expression generated by the retrieval expression generation unit 211b.

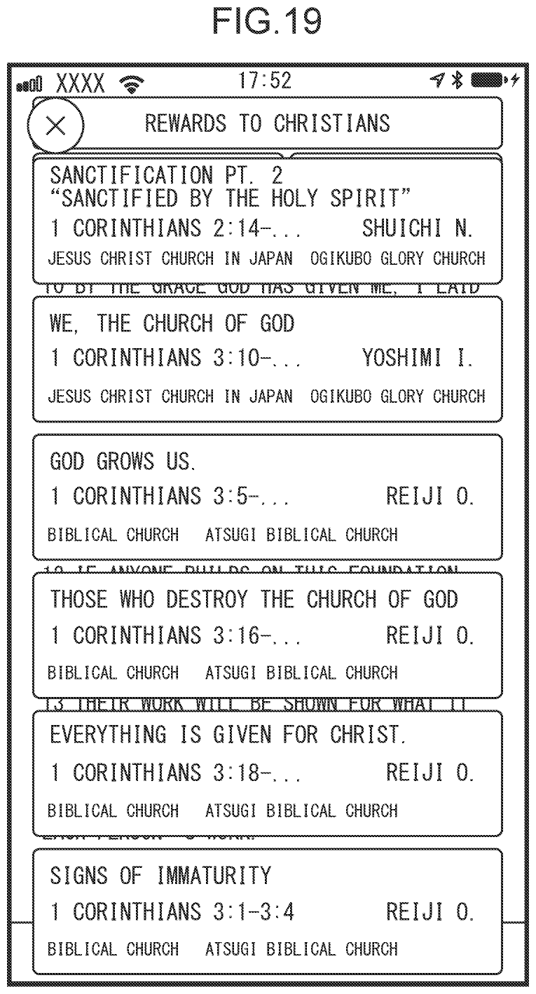

Each of titles of the plurality of retrieved preachings “We, the church of GOD”, “We, the church of GOD”, . . . , “signs of immaturity” are displayed as shown in FIG. 19.

If “We, the church of GOD” is selected on the screen of FIG. 19, a screen of a preaching of “We, the church of GOD” is displayed as shown in FIG. 21.

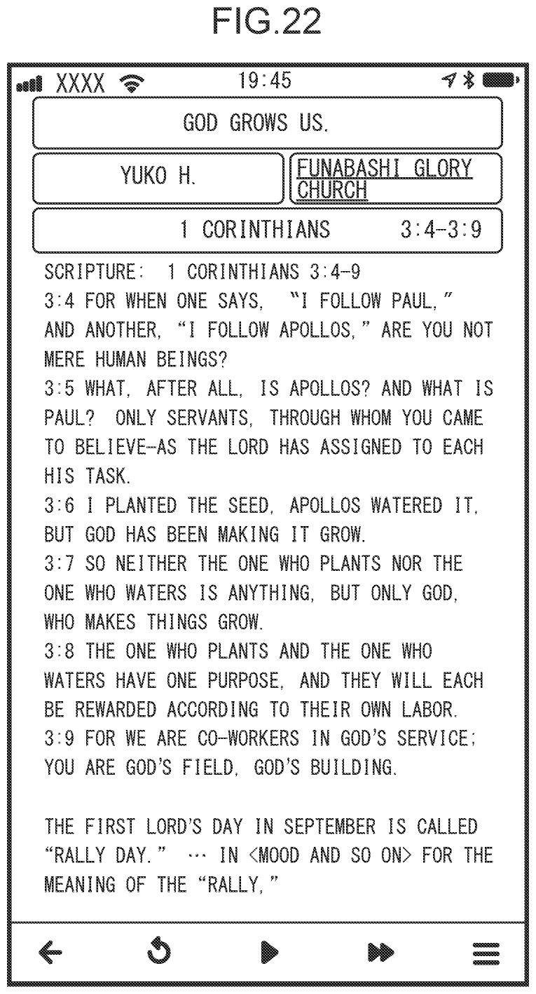

In addition, if “GOD grows us” is selected on the screen of FIG. 19, the preaching of the “GOD grows us” is displayed on the screen as shown in FIG. 22.

If the “citing the same block” is selected, since the Bible shown in FIG. 16 is the First epistle to the Corinthians Chapter 3 Verse 10 to Chapter 3 Verse 15, from the preaching table 303, a retrieval expression for retrieving a record in which a numerical value of a book is a numerical value corresponding to the epistle to the Corinthians is generated by the retrieval expression generation unit 211b.

The retrieval unit 211c retrieves the preaching table 303 using the retrieval expression generated by the retrieval expression generation unit 211b.

The illustration of the retrieval results is omitted.

### Second Embodiment

The first embodiment was based on the premise that one preaching cites only successive parts of one book. On the other hand, a second embodiment corresponds to the case where one preaching cites portions cited in a discrete relationship with each other. For example, it corresponds to a preaching which cites a plurality of portions discrete from each other in the same book or a plurality of portions of different books.

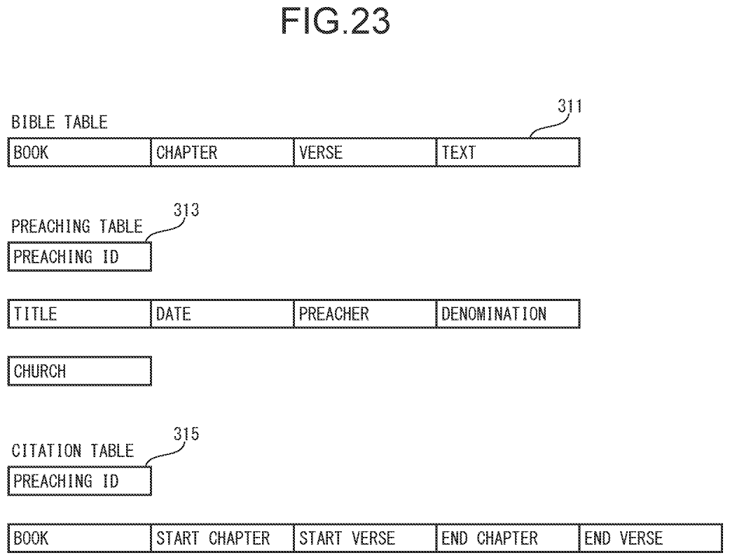

In order to make this possible, a database is changed from that shown in FIG. 2 to that shown in FIG. 23.

The database shown in FIG. 23 includes a Bible table 311, a preaching table 313, and a citation table 315.

The bible table 311 has fields of books, chapters, verses, and texts. The Bible table 311 includes texts corresponding to 39 Old Testament volumes and 27 New Testament volumes. However, the texts are divided every volume and every verse and each record stores each volume number, each verse number, and texts corresponding to these combinations. For example, Genesis Chapter 1 Verse 1 “In the beginning God created the heaven and the earth” as a text is recorded in one record in which a book number is 1, a chapter number is 1, and a verse number is 1. In addition, “the genealogy of Jesus Christ, the son of David, the son of Abraham” in the Gospel of Matthew Chapter 1 Verse 1, as a text is recorded in one record in which a book number is 40 and a chapter number is 1.

The preaching table 313 has fields of a preaching ID, a title, a date, a preacher, a denomination, and a church.

The citation table 315 has fields of a preaching ID, book, a start chapter, a start verse, an end chapter, and an end verse.

The preaching table 313 and the citation table 315 have a one-to-many relationship. That is, the preaching table 311 has only one record for the same preaching ID, but the citation table 313 has one or more records for the same preaching ID.

As a result, as described above, one preaching can correspond to citing portions cited having a discrete relationship from each other.

In the second embodiment, a normal display is performed in the same manner as in the first embodiment.

FIG. 16 is a screen of a preaching of “Reward for Christians”, citing the First epistle to the Corinthians-3.10-3.15 displayed as a result of a predetermined operation.

FIG. 17 is a diagram showing a pop-up menu for selecting which preaching is retrieved when a menu button at the bottom right corner on the screen of a preaching of “Reward for Christians” shown in FIG. 16 is pressed.

The pop-up menu includes the following menu items as the menu items.

Citing the same verse

Citing the same chapter

Citing the same book

Canceling

If the “citing the same verse” is selected, since the Bible shown in FIG. 16 is the First epistle to the Corinthians Chapter 3 Verse 10 to Chapter 3 Verse 15, from the citation table 315, a retrieval expression for retrieving a record in which a numerical value of a book is a numerical value corresponding to the epistle to the Corinthians, and at least one of one or more chapters and verses included in a start chapter and a start verse to an end chapter and an end verse is a range from Chapter 3 Verse 10 to Chapter 3 Verse 15 is generated by the retrieval expression generation unit 211b.

Instead, from the citation table 315, a retrieval expression for retrieving a record in which the numerical value of the book is the numerical value corresponding to the epistle to the Corinthians and a start chapter and a start verse is Chapter 3 Verse 10 may be generated by the retrieval expression generation unit 211b.

In addition, from the citation table 315, a retrieval expression for retrieving a record in which the numerical value of the book is the numerical value corresponding to the epistle to the Corinthians, and a start chapter and a start verse is Chapter 3 Verse 10 and an end chapter and an end verse is Chapter 3 Verse 15 may be generated by the retrieval expression generation unit 211b.

The retrieval unit 211c retrieves the citation table 315 using the retrieval expression generated by the retrieval expression generation unit 211b.

Next, the record having the same preaching ID as the preaching ID of the record retrieved from the citation table 315 is retrieved from the preaching table 313.

The only preaching title “We, the church of GOD” retrieved from the preaching table 315 is displayed as shown in FIG. 18.

If “We, the church of GOD” is selected on the screen of FIG. 18, a screen of a preaching of “We, the church of GOD” is displayed as shown in FIG. 21.

If the “citing the same chapter” is selected, since the Bible shown in FIG. 16 is the First epistle to the Corinthians Chapter 3 Verse 10 to Chapter 3 Verse 15, from the citation table 315, a retrieval expression for retrieving a record in which a numerical value of a book is a numerical value corresponding to the epistle to the Corinthians, and at least one of one or more chapters included in a start chapter to an end chapter is a range from Chapter 3 is generated by the retrieval expression generation unit 211b.

Instead, from the citation table 315, a retrieval expression for retrieving a record in which a numerical value of the book is a numerical value corresponding to the epistle to the Corinthians, and a start chapter is Chapter 3 may be generated by the retrieval expression generation unit 211b.

In addition, from the citation table 315, a retrieval expression for retrieving a record in which a numerical value of the book is a numerical value corresponding to the epistle to the Corinthians, a start chapter is Chapter 3, and an end chapter is Chapter 3 may be generated by the retrieval expression generation unit 211b.

The retrieval unit 211c retrieves the citation table 303 using the retrieval expression generated by the retrieval expression generation unit 211b.

Next, the record having the same preaching ID as the preaching ID of the record retrieved from the citation table 315 is retrieved from the preaching table 313.

Each of the plurality of preaching titles “Sanctification PT.2 sanctified of the Holy Spirit”, “We, the church of GOD”, . . . , “signs of immaturity” retrieved from the preaching table 313 is displayed as shown in FIG. 19.

If “We, the church of GOD” is selected on the screen of FIG. 19, a screen of a preaching of “We, the church of GOD” is displayed as shown in FIG. 21.

In addition, if “GOD grows us” is selected on the screen of FIG. 19, the preaching of the “GOD grows us” is displayed on the screen as shown in FIG. 22.

If the “citing the same block” is selected, since the Bible shown in FIG. 16 is the First epistle to the Corinthians Chapter 3 Verse 10 to Chapter 3 Verse 15, from the citation table 315, a retrieval expression for retrieving a record in which a numerical value of a book is a numerical value corresponding to the epistle to the Corinthians is generated by the retrieval expression generation unit 211b.

The retrieval unit 211c retrieves the citation table 315 using the retrieval expression generated by the retrieval expression generation unit 211b.

Next, the record having the same preaching ID as the preaching ID of the record retrieved from the citation table 315 is retrieved from the preaching table 313.

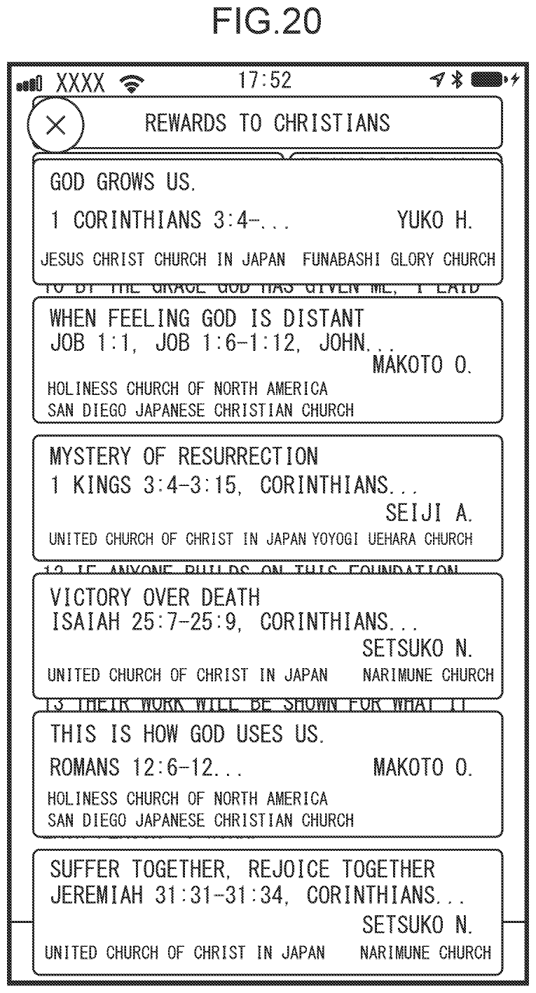

Each title of the plurality of preachings “GOD grows us”, “When GOD feels distant”, . . . , “All suffer together, rejoice together” retrieved from the preaching table 313 are displayed as shown in FIG. 20.

### Third Embodiment

Instead of the fields of the book, the start chapter, the start verse, and the end chapter, and the end verse, a preaching table may have fields of the biblical cited portions represented by them.

For example, in the case of a record in which book=1, start chapter=1, start verse=1, end chapter=21, and end verse=21, the preaching table may have fields of the biblical cited portions of “Genesis 21.1-21.21.”

In this case, in the case of retrieving the preaching “citing the same verse”, string processing is performed. In other words, a record in which the “Genesis 21.1” is included in the field of biblical cited portions, a record in which the “Genesis 21.2” is included in the field of the biblical cited portions, . . . , a record in which the “Genesis 21.21” is included in the field of the biblical cited portions are retrieved.

In the case of retrieving the preaching “citing the same chapter”, string processing is performed. That is, a record in which the “Genesis 21.*” is included in the field of the biblical cited portions is retrieved. Here, “*” is a character string of any one or more characters.

In the case of retrieving the preaching “citing the same block”, string processing is performed. That is, a record in which the “Genesis*” is included in the field of the biblical cited portions is retrieved. Here, “*” is a character string of any one or more characters.

### Fourth Embodiment

A fourth embodiment relates to the biblical cited portions commonly cited among preachings.

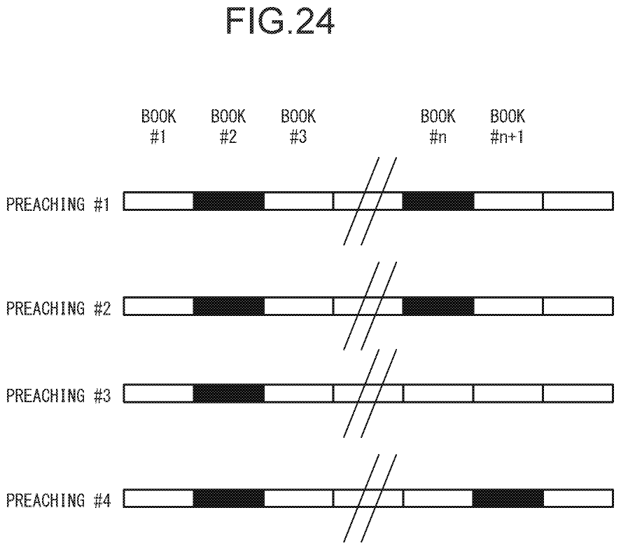

FIG. 24 shows, in a book unit, cited portions cited by four preachings, preaching #1, preaching #2, preaching #3, and preaching #4. A blackened chapter is a book in which a preaching is cited in whole or in part.

In the case where the preaching #1 is set as a reference, the preaching whose cited portions completely match in a book unit is the preaching #2.

In the case where the preaching #1 is set as a reference, a preaching whose cited portions at least partially match in a book unit is the preaching #2, the preaching #3, and the preaching #4.

In order to retrieve the preaching which is set as the reference and the preaching whose cited portions completely match in a block unit, the following is performed.

(11) List up all the books of the biblical cited portions cited by the preaching set as the reference. Here, only a part of the books which are cited is considered to be a cited book.

(12) List up all the books of the biblical cited portions cited by the preaching to be compared. Here, a book which is only partially cited is also considered to be a cited book.

(13) If all of the books listed up in the (11) and the books listed up in the (12) match, the preaching to be compared determines that the cited portions completely match in a book unit.

In order to retrieve the preaching which is set as the reference and the preaching whose cited portions at least partially match in a block unit, the following is performed.

(21) List up all the books of the biblical cited portions cited by the preaching set as the reference. Here, a book which is only partially cited is also considered to be a cited book.

(22) List up all the books of the biblical cited portions cited by the preaching to be compared. Here, a book which is only partially cited is also considered to be a cited book.

(23) If the books listed up in the (21) and the books listed up in the (22) partially or completely match, the preaching to be compared determines that the cited portions at least partially match in a book unit.

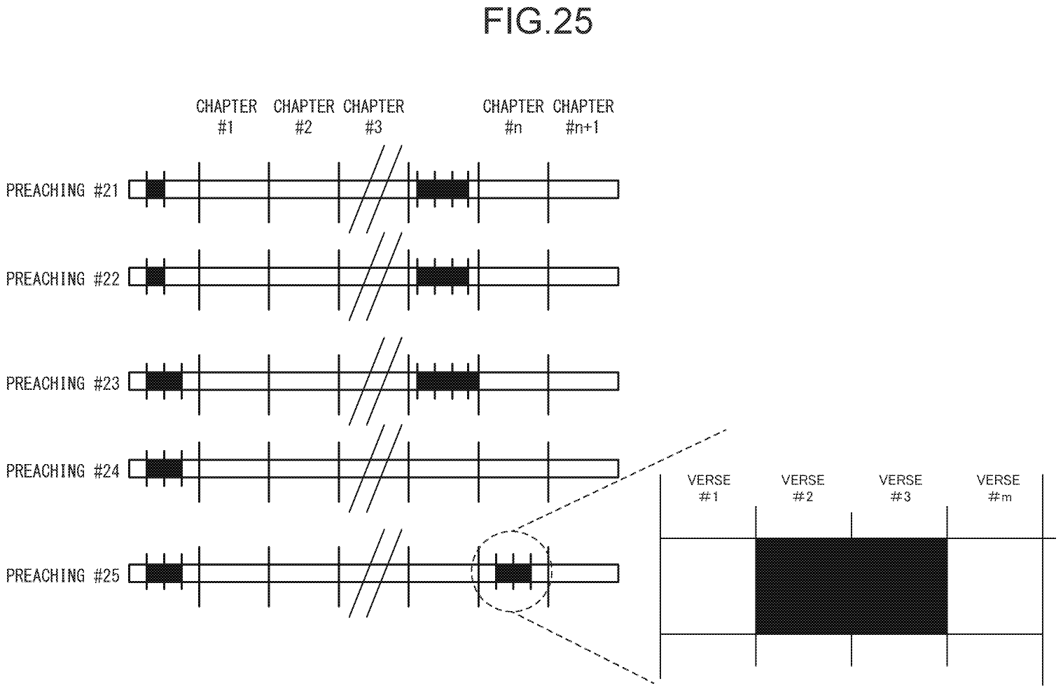

FIG. 25 shows, in a book unit, cited portions cited by five preachings, preaching #21, preaching #22, preaching #23, preaching #24, and preaching #25. The blackened parts are sections cited by the preaching.

In the case where the preaching #21 is set as a reference, a preaching whose cited portions completely match in a chapter unit is the preachings #22 and #23.

In the case where the preaching #21 is set as a reference, a preaching whose cited portions at least partially match in a chapter unit is the preaching #22, the preaching #23, the preaching #24, and the preaching #25.

In order to retrieve the preaching which is set as the reference and the preaching whose cited portions completely match in a chapter unit, the following is performed.

(31) List up all the chapters of the biblical cited portions cited by the preaching set as the reference. Here, a chapter which is only partially cited is also considered to be a cited chapter.

(32) List up all the chapters of the biblical cited portions cited by the preaching to be compared. Here, a chapter which is only partially cited is also considered to be a cited chapter.

(33) If all of the chapters listed up in the (31) and the chapters listed up in the (32) match, the preaching to be compared determines that the cited portions completely match in a chapter unit.

In order to retrieve the preaching which is set as the reference and the preaching whose cited portions at least partially match in a chapter unit, the following is performed.

(41) List up all the chapters of the biblical cited portions cited by the preaching set as the reference. Here, a chapter which is only partially cited is also considered to be a cited chapter.

(42) List up all the chapters of the biblical cited portions cited by the preaching to be compared. Here, a chapter which is only partially cited is also considered to be a cited chapter.

(43) If the chapters listed up in the (41) and the chapters listed up in the (42) partially or completely match, the preaching to be compared determines that the cited portions at least partially match in a chapter unit.

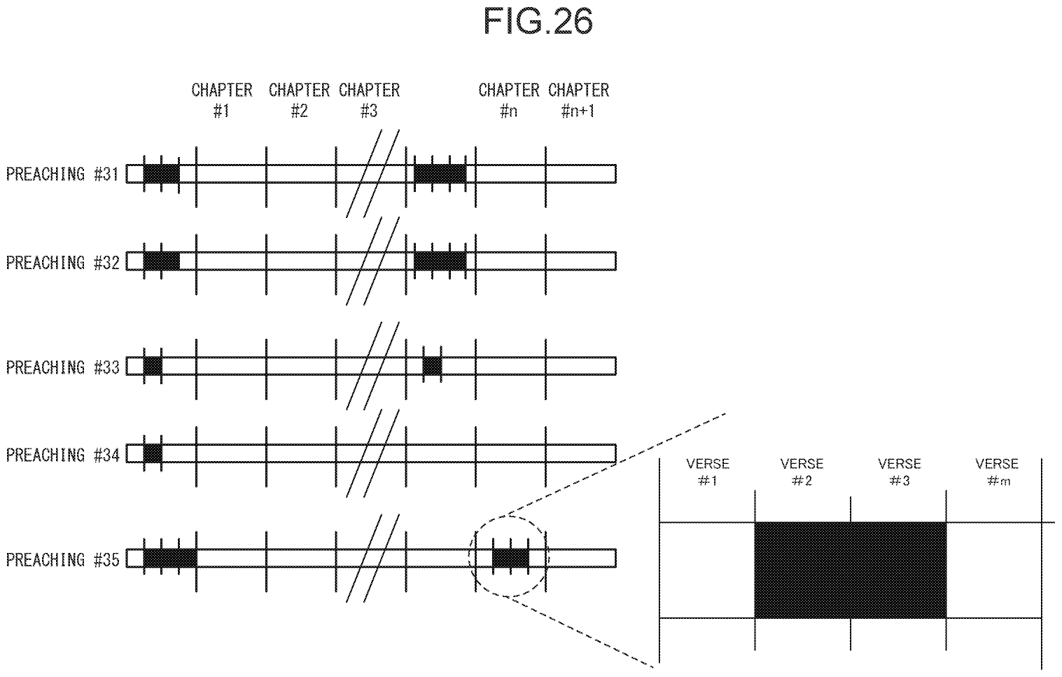

FIG. 26 shows, in a book unit, cited portions cited by five preachings, preaching #31, preaching #32, preaching #33, preaching #34, and preaching #35. The blackened parts are verses cited by the preaching.

In the case where the preaching #31 shown in FIG. 26 is set as a reference, a preaching whose cited portions completely match in a verse unit is only the preaching #32.

In the case where the preaching #31 shown in FIG. 26 is set as a reference, a preaching whose cited portions partially match in a verse unit is the preaching #32, the preaching #33, the preaching #34, and the preaching #35. However, the preaching #35 which also cites other chapters may be excluded.

In order to retrieve the preaching which is set as the reference and the preaching whose cited portions completely match in a verse unit, the following is performed.

(51) List up all the verses of the biblical cited portions cited by the preaching set as the reference.

(52) List up all the verses of the biblical cited portions cited by the preaching to be compared.

(53) If all of the verses listed up in the (51) and the verses listed up in the (52) match, the preaching to be compared determines that the cited portions completely match in a verse unit.

In order to retrieve the preaching which is set as the reference and the preaching whose cited portions partially or completely match in a chapter unit, the following is performed.

(61) List up all the verses of the biblical cited portions cited by the preaching set as the reference.

(62) List up all the verses of the biblical cited portions cited by the preaching to be compared.

(63) If the verses listed up in the (61) and the verses listed up in the (62) partially or completely match, the preaching to be compared determines that the cited portions completely match in a verse unit.

### Fifth Embodiment

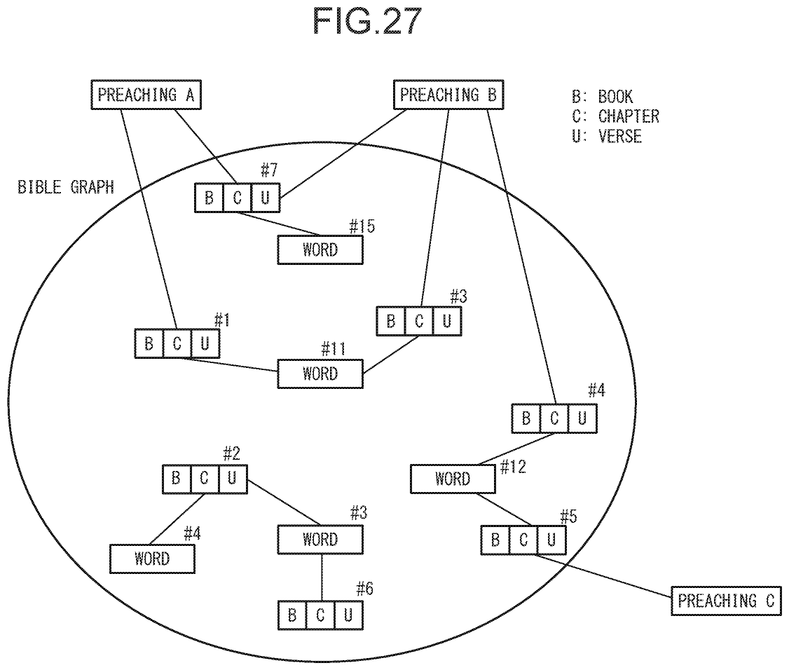

A fifth embodiment uses bible data described in a Unified Scripture Format XML (USFX) format. This makes it possible to construct a bible graph described in FIG. 27. Here, word groups in books, chapters, and verses of the Bible can be expressed as a graph structure based on a semantic connection specified in the USFX format. Similarity between preachings can be calculated by retrieving word cited by a preaching and the bible graph. For example, it is assumed that preaching A cites BCV1 and BCV7. On the other hand, it is assumed that preaching B cites BCV3, BCV4, and BCV7. In addition, it is assumed that preaching C cites BCV5. In this situation, the preaching A and the preaching B have a reachable relationship with WORD 11 and WORD 15 as common, and the preaching B and the preaching C has a reachable relationship with WORD 12 as common. Here, if it is defined that the relationship between the preaching A and the preaching B is stronger than the relationship between the preaching B and the preaching C from the number of connections, it is possible to reply to the retrieve for listing the preaching related to the preaching B in the order of the preaching A and the preaching C.

The preaching having the reply can be displayed on the screen of the portable information terminal as in the above embodiments, for example, in the mode as shown in FIG. 10, and the selected preaching can be displayed on the screen.

Although not shown, a menu item called the preaching related to the current preaching may be added to the pop-up menu shown in FIG. 17. In this case, it is possible to display the preaching having the reply, for example, in a mode as shown in FIG. 18 and to display the selected preaching on the screen.

In the case of the biblical cited portions, it is specified by the books, the chapters, or the verses in the Bible, but in the case of the word, it may be listed in the plurality of portions in the Bible, so the relationship between the word and a set of the books, chapters, and verses is generally one-to-many.

In the case of adding the description of the word, for example, the Genesis Chapter 1 Verse 1 is “In the beginning God created the heaven and the earth”, but the word is six such as “In the beginning”, “God”, “created”, “the heaven”, “and”, “the earth”. For example, “In the beginning” has an ID as a word, and in the text of the Bible, words having the same meaning also have the same ID. For example, the same ID as “In the beginning” is also attached to the first “The first” of Exodus Chapter 23 Verse 19, “The first of the first fruits of thy land thou shalt bring unto the house of the LORD thy God”. Since the bible graphs have a data structure which is not dependent on languages such as Japanese and English, if the bible graph is used in calculations which list the related preachings, it is possible to list the related preachings across languages. For example, it is possible to list the preachings, which are related to the preachings written in Japanese, from the preachings written in English.

### Sixth Embodiment

In a sixth embodiment, for example, a management server takes in new preachings and updates a database every week. The management server transmits the updated database to each portable information processing apparatus. Only the difference may be transmitted, and in this case, the portable information processing apparatus updates the database based on the difference.

### Seventh Embodiment

In this embodiment, all retrievals regarding all the types of retrieval and all the preachings as references are performed beforehand, and then retrieval reference data containing the relation between retrieval and the result of the retrieval for all the retrievals is stored beforehand. Such retrieval reference data is referred to in each retrieval performed thereafter. A management server reference data for retrieval may be created and transmitted to each portable information processing apparatus, or each portable information processing apparatus may generate the management server reference data for retrieval at an idle time.

In addition, when the database is updated as in the sixth embodiment, the reference data for retrieval is also updated according to the update of the database. The management server transmits the updated reference data for retrieval to each portable information processing apparatus together with the updated database. The portable information processing apparatus may generate the reference data for retrieval corresponding to the updated database at an idle time.

### Eighth Embodiment

In the above embodiments, as shown in FIG. 1, a portable information processing apparatus 201 includes a database 213b, a retrieval expression generation unit 211b, and a retrieval unit 211c.

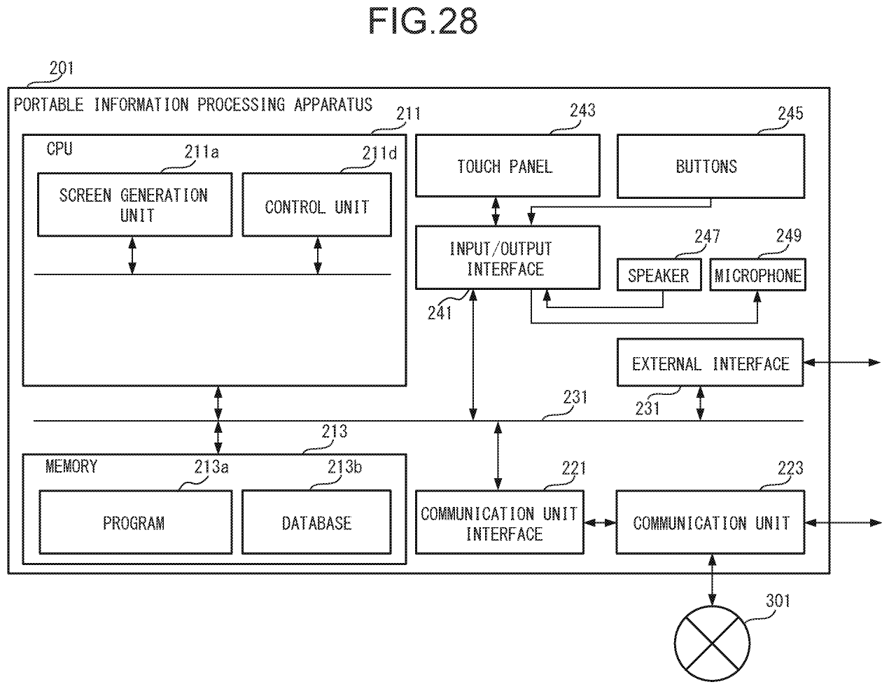

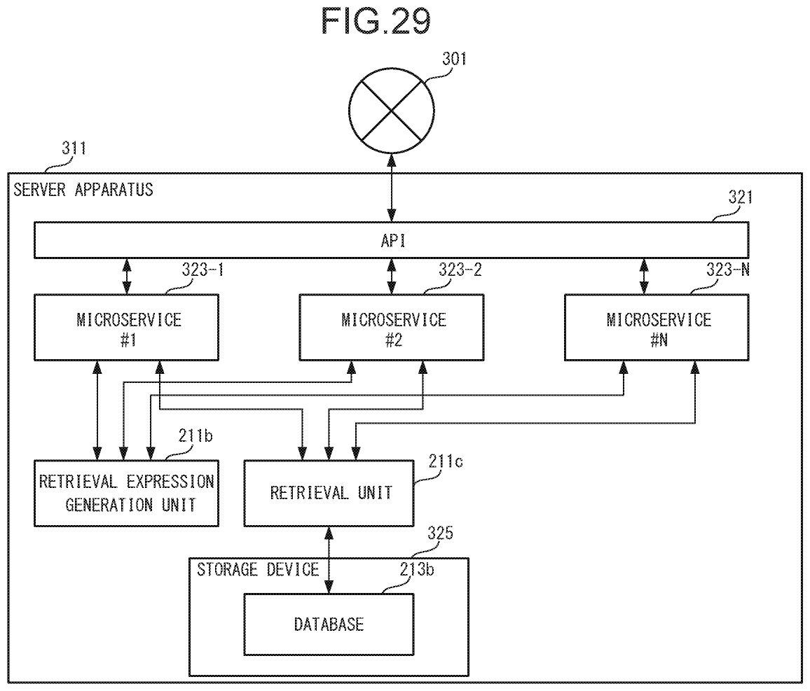

On the other hand, in an eighth embodiment, as shown in FIGS. 28 and 29, the retrieval expression generation unit 211b, the retrieval unit 211c, and the database 213b are removed from the portable information processing apparatus 201. A server apparatus 311 configured to communicate with the portable information processing apparatus 201 via the Internet 301 includes the retrieval expression generation unit 211b, the retrieval unit 211c, and the database 213b. In addition, the server apparatus 311 also includes an application programming interface (API) 321, a plurality of microservices 323-1 to 323-N, and a storage device 325. In addition, the portable information processing apparatus 201 includes a memory 213 in which a database cache 213b for temporarily storing retrieval results from the database 213b transmitted from the server apparatus 311 is built.

A control unit 211d included in the portable information processing apparatus 201 activates any of the microservices 323-1 to 323-N in accordance with the specifications of the API 321. The activated microservice 321-n (n is any of 1, 2, . . . , N) retrieves necessary data from the database 213b using the retrieval expression generation unit 211b and the retrieval unit 211c, and transmits the retrieved data to the control unit 211d via the API 321. The control unit 211 stores the retrieval result transmitted from the server apparatus 311 in the database cache 213b.

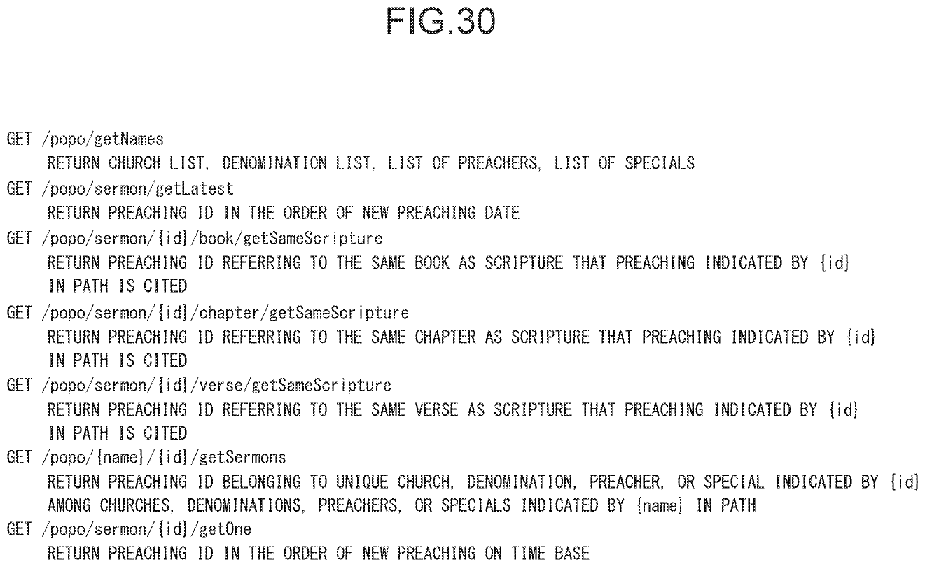

FIG. 30 shows an example of the specifications of the API.

### Ninth Embodiment

In a ninth embodiment, related preachings may be listed by vectorizing and comparing texts of preachings themselves by deep learning algorithms. For example, as the algorithms, algorithms such as Skip-thought (https://arxiv.org/abs/1506.06726) or Skip-gram (https://arxiv.org/pdf/1301.3781v3.pdf) may be used, and other algorithms may also be used.

The above-described portable information processing apparatus can be realized by hardware, software, or a combination thereof. In addition, the method for providing preachings performed by the above-described portable information processing apparatus can also be realized by hardware, software, or a combination thereof. Here, the realization by the software means realization by a computer which reads and executes a program.

The program can be stored in and provided to a computer using various types of non-transitory computer readable media. The non-transitory computer readable media include various types of tangible storage media. Examples of the non-transitory computer readable media include magnetic recording media (for example, flexible disks, magnetic tapes, hard disk drives), magneto-optical recording media (for example, magneto-optical disks), CD-read only memory (CD-ROM), CD-R, CD-R/W, and semiconductor memories (for example, a mask ROM, a programmable ROM (PROM), an erasable PROM (EPROM), a flash ROM, and a random access memory (RAM)). In addition, the program may also be provided to the computer by various types of transitory computer readable media. Examples of the temporary computer readable media include electrical signals, light signals, and electromagnetic waves. The temporary computer readable media can provide the program to the computer via a wired communication path such as an electric wire and an optical fiber, or a wireless communication path.

The present invention can be used to provide a preaching.

1. A computer-readable medium on which a computer program is recorded, said computer program causes, when executed, the computer to perform a method comprising the steps of:
a) displaying a preaching on a display, said preaching citing at least one portion in the Bible;
b) retrieving at least one preaching which includes a common portion with the preaching displayed at step a) or at least one preaching which is related to the preaching displayed at step a), said common portion includes at least one cited portion or Lord's word in the Bible which is commonly cited from said preaching displayed at step a) and said at least one preaching retrieved at step b);
c) displaying a list including said at least one preaching retrieved at step b); and
d) displaying a preaching selected from said list displayed at step c).

2. The computer-readable medium on which a computer program is recorded according to claim 1, wherein the method further includes the step of:
e) allowing a user to select a book, a chapter, or a verse of the Bible as a retrieval unit,
wherein at step b), at least one preaching which includes a common portion with the preaching displayed at step a) is retrieved, said common portion includes at least one cited portion in the Bible which is commonly cited from said preaching displayed at step a) and said at least one preaching retrieved at step b) in said retrieval unit.

3. The computer-readable medium on which a computer program is recorded according to claim 1, wherein the method further includes the steps of:
f) displaying a main menu including a latest preaching, preachings for each church, preachings for each denomination, preachings for each preacher, a special preaching series as a menu item;
g) displaying a list of preachings or a secondary menu corresponding to a menu item selected in said main menu; and
h) displaying a list of preachings corresponding to a secondary menu item selected in the secondary menu when the secondary menu is displayed at step g),
wherein the preaching selected in said list of preachings is displayed at step a).

4. A computer-readable medium on which a computer program is recorded, said computer program causes, when executed, the computer to perform a method comprising the steps of:
a) displaying a preaching on a display, said preaching citing at least one portion in the Bible;
b) causing another computer to retrieve at least one preaching which includes a common portion with the preaching displayed at step a) or at least one preaching which is related to the preaching displayed at step a), said common portion includes at least one cited portion or Lord's word in the Bible which is commonly cited from said preaching displayed at step a) and said at least one preaching retrieved at step b);
c) displaying a list including said at least one preaching retrieved at step b); and
d) displaying a preaching selected from said list displayed at step c).

5. The computer-readable medium on which a computer program is recorded according to claim 4, wherein the method further includes the step of:
e) allowing a user to select a book, a chapter, or a verse of the Bible as a retrieval unit,
wherein at step b), at least one preaching which includes a common portion with the preaching displayed at step a) is retrieved by said another computer, said common portion includes at least one cited portion in the Bible which is commonly cited from said preaching displayed at step a) and said at least one preaching retrieved at step b) in said retrieval unit.

6. The computer-readable medium on which a computer program is recorded according to claim 4, wherein the method further includes the steps of:
f) displaying a main menu including a latest preaching, preachings for each church, preachings for each denomination, preachings for each preacher, a preaching series feature as a menu item;
g) displaying a list of preachings or a secondary menu corresponding to a menu item selected in said main menu; and
h) displaying a list of preachings corresponding to a secondary menu item selected in the secondary menu when the secondary menu is displayed at step g),
wherein the preaching selected in the list of preachings is displayed at step a).
